(19) United States
(12) Patent Application Publication
(10) Pub. No.: US 2019/0166078 A1
(43) Pub. Date: May 30, 2019

(54) SOCIAL-NETWORK INFORMATION CONNECTION SYSTEM

(71) Applicant: SPEED 3D Inc., Taipei City (TW)

(72) Inventors: Shiann-Tsong Tsai, Taipei City (TW); Li-Chuan Chiu, Taipei City (TW); Wei-Meen Liao, Taipei City (TW)

(21) Appl. No.: 15/856,063

(22) Filed: Dec. 28, 2017

(30) Foreign Application Priority Data
Nov. 27, 2017 (CN) 201711208935.9

(51) Int. Cl. H04L 12/58

(52) U.S. Cl. CPC H04L 51/08; G06Q 50/01; H04L 51/38

(57) ABSTRACT

Asocial-network information connection system includes a management device and a mobile device. The management device captures a physical card to generate a picture-and-text image. The management device further records a voice message and connects a recognition feature, the picture-and-text image, a three-dimensional pattern, and the voice message with each other to have a relationship. The electronic device recognizes a card having the recognition feature. The mobile device executes the application program to connect with the management device to transmit a recognition signal corresponding to the recognition feature to the management device. The management device looks up the three-dimensional pattern and the voice message according to recognition signal and transmits the three-dimensional pattern and the voice message to the mobile device. The mobile device outputs the three-dimensional pattern and the voice message.

### BACKGROUND OF THE INVENTION

### 1. Field of the Invention

The present invention relates to an information connection system, in particular to an interactive social-network information connection system.

### 2. Description of the Prior Art

In common social occasions, people know each other by exchanging their business cards, yet the interaction between people is much poorer. Moreover, the information on the business cards is also limited. Therefore, people tend to use social media platforms like Facebook, Weibo, or LinkedIn to further search and realize other people. However, these platforms have limited performance.

### SUMMARY OF THE INVENTION

In view of these problems, an embodiment of the present invention provides a social-network information connection system. The system comprises a processing module, an image-capturing module, and a storage module. The image-capturing module captures a physical card to generate a picture-and-text image. The processing module selects a content to be a recognition feature according to the picture-and-text image. The image-capturing module captures a physical object to generate a three-dimensional pattern. The image-capturing module further records a voice message. The storage module stores the recognition feature, the picture-and-text image, the three-dimensional pattern, and the voice message. The processing module processes the recognition feature, the picture-and-text image, the three-dimensional pattern, and the voice message have a relationship with each other. The mobile device comprises a recognition module, a storage module, a communication module, and an output module. The storage module of the mobile device stores an application program. The recognition module is adapted to recognize a second physical card having the recognition feature. The mobile device executes the application program to connect with the management device to transmit a recognition signal corresponding to the recognition feature to the management device by the communication module. The management device looks up the three-dimensional pattern and the voice message according to recognition signal and transmits the three-dimensional pattern and the voice message to the mobile device. The mobile device outputs the three-dimensional pattern and the voice message by the output module.

Another embodiment of the present invention provides a social-network information connection system. The system is adapted to be connected with a first mobile device. The system comprises a management device and a physical card. The management device comprises a storage module. The storage module stores a recognition feature, a picture-and-text image, and a three-dimensional pattern. The recognition feature, the picture-and-text image, and the three-dimensional pattern have a relationship. The physical card has the recognition feature. The first mobile device comprises a first recognition module, a first storage module, a first communication module, a first output module. The first storage module stores an application program. The first mobile device executes the application program to connect with the management device. When the first recognition module recognizes the recognition feature, the first mobile device transmits a first recognition signal to the management device via the first communication module. The management device looks up the three-dimensional pattern according to the first recognition signal and transmits the three-dimensional pattern to the first mobile device. The first mobile device combines a voice message with the three-dimensional pattern to form a feature image and stores the feature image. The first mobile device further transmits the feature image to the management device.

Yet another embodiment of the present invention provides a social-network information connection system. The system is adapted to be connected with a first mobile device and the system comprises a management device and a physical card. The management device comprises a storage module storing a recognition feature, a picture-and-text image, a three dimensional pattern, and a voice message. The recognition feature, the picture-and-text image, the three-dimensional pattern, and the voice message have a relationship. The voice message and the three-dimensional pattern are combined to form a feature image. The physical card has a recognition feature. The first mobile device comprises a first recognition module, a first storage module, a first communication module, and a first output module. The first storage module stores an application program. The first mobile device executes the application program to connect with the management device. When the first recognition module recognizes the recognition feature, the first mobile device transmits a first recognition signal to the management device via the first communication module. The management device looks up the feature image according to the first recognition signal and transmits the feature image to the first mobile device. The first mobile device receives the feature image and then outputs the feature image via the first output module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic view of a social-network information connection system according to an exemplary embodiment of the present invention;

FIG. 2 illustrates an operational schematic view of a social-network information connection system according to an exemplary embodiment of the present invention;

FIG. 3 illustrates a schematic view of a social-network information connection system according to an exemplary embodiment of the present invention;

FIG. 4A illustrates a schematic view of a social-network information connection system according to an exemplary embodiment of the present invention;

FIG. 4B illustrates an operational schematic view of a social-network information connection system according to an exemplary embodiment of the present invention;

FIG. 4C illustrates a schematic view of a social-network information connection system according to an exemplary embodiment of the present invention; and

FIG. 5 illustrates a schematic scenario of a social-network information connection system according to an exemplary embodiment of the present invention.

### DETAILED DESCRIPTION

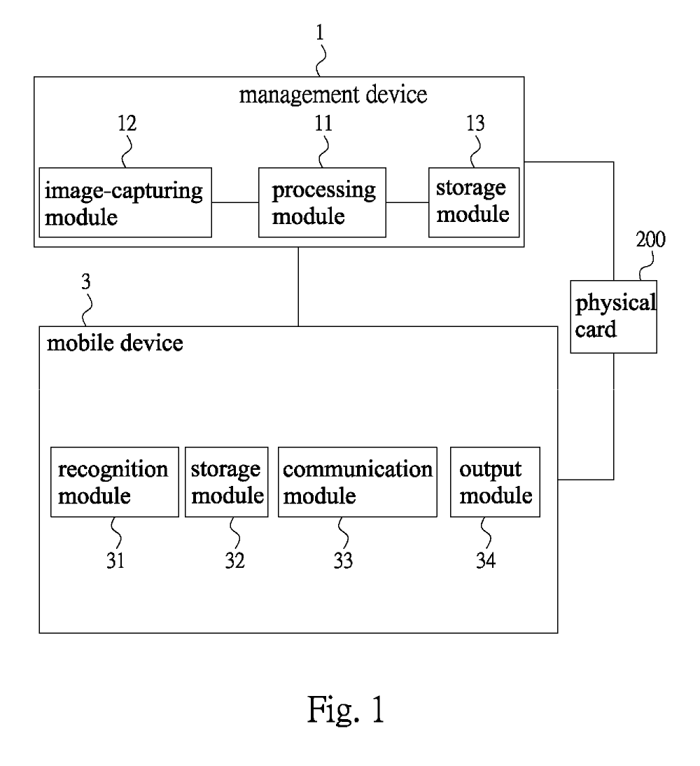

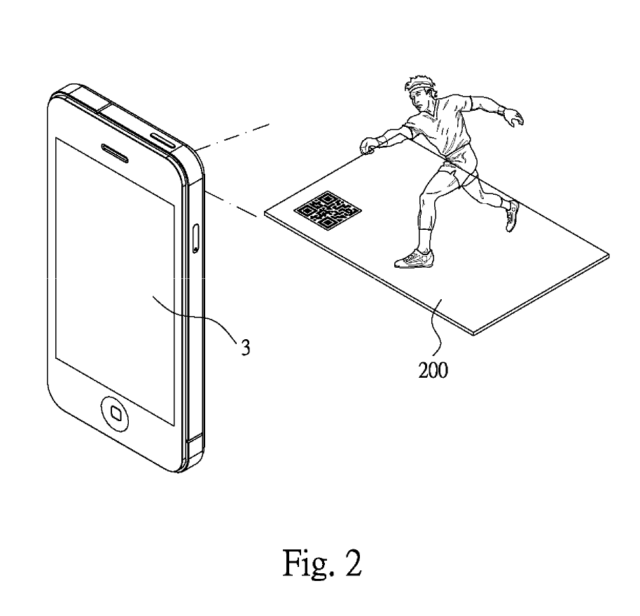

Please refer to FIGS. 1 and 2, respectively illustrating a schematic view and an operational schematic view of the social-network information connection system 100 according to an exemplary embodiment of the present invention. The social-network information connection system 100 comprises a management device 1 and a mobile device 3. The management device 1 comprises a processing module 11, an image-capturing module 12, and a storage module 13. The image-capturing module 12 captures a physical card 200 to generate a picture-and-text image. The physical card 200 may be a business card. The business card has texts, a recognition code or recognition patterns, for example, barcodes, QR codes, or AR standing points. The processing module 11 selects a content to be a recognition feature according to the picture-and-text image. For example, the processing module 11 may select the recognition code to be the recognition feature. The image-capturing module 12 further captures a physical object to generate a three-dimensional pattern. The physical object may be a user's face or the user himself/herself. The three-dimensional pattern may be a dynamic human face (i.e., 3D Avatar) or a dynamic human body. The image-capturing module 12 further records a voice message. The voice message may be a self-introduction of the person being captured, a music stream, etc. The storage module 13 stores the recognition feature, the picture-and-text image, the three-dimensional pattern, and the voice message. The processing module 11 processes the recognition feature, the picture-and-text image, the three-dimensional pattern, and the voice message to have a relationship with each other. The mobile device 3 comprises a recognition module 31, a storage module 32, a communication module 33, and an output module 34. The storage module 32 stores an application program. The recognition module 31 recognizes another physical card 200 having the recognition feature (or the same physical card 200). The mobile device 3 executes the application program to connect with the management device 1 to transmit a recognition signal corresponding to the recognition feature to the management device 1 by the communication module 33. Next, the management device 1 looks up the three-dimensional pattern and the voice message according to the recognition signal and transmits the three-dimensional pattern and the voice message to the mobile device 3. The mobile device 3 then outputs the three-dimensional pattern and the voice message by the output module 34. The mobile device 3 further combines the three-dimensional pattern with the voice message to form a feature image and stores the feature image. The mobile device 3 may be, for example, a smartphone or a tablet computer. When the mobile device 3 recognizes the barcode or the QR code on the card with the recognition module 31, the mobile device 3 receives the feature image transmitted by the management device 1 and then outputs the feature image by displaying or projecting. In one embodiment, the mobile device 3 has a media player for playing the voice message of the feature image. In a scenario, the card may be a business card, and the feature image is a self-introduction or a show demonstrated by the person recited in the business card. In one embodiment, the management device 1 stores information related to the person, so that a user can use the application program in the mobile device 3 to connect with the management device 1 for searching such information.

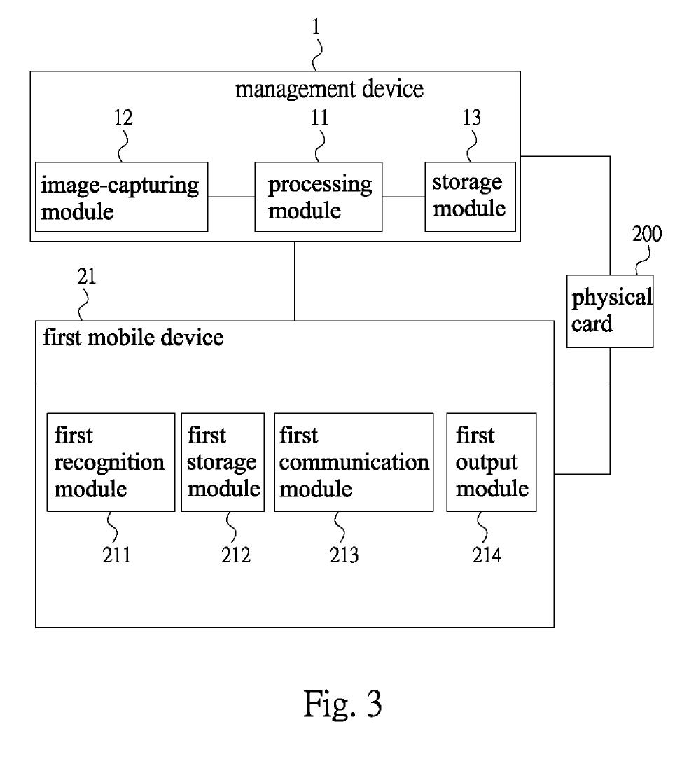

Please refer to FIG. 3, illustrating a schematic view of a social-network information connection system 100 according to an exemplary embodiment of the present invention. In this embodiment, the social-network information connection system 100 is adapted to be connected with a first mobile device 21, and the social-network information connection system 100 comprises a management device 1 and a physical card 200. The management device 1 comprises a storage module 13 storing a recognition feature, a picture-and-text image, and a three-dimensional pattern. The recognition feature, the picture-and-text image, and the three-dimensional pattern have a relationship. The physical card 200 has the recognition feature. The first mobile device 21 comprises a first recognition module 211, a first storage module 212, a first communication module 213, and a first output module 214. The first storage module 212 stores an application program. The first mobile device 21 executes the application program to connect with the management device. When the first recognition module 211 recognizes the recognition feature, the first mobile device 21 transmits a first recognition signal to the management device 1 by the first communication module 213. The management device 1 looks up the three-dimensional pattern according to the first recognition signal and transmits the three-dimensional pattern to the first mobile device 21. The first mobile device 21 combines a voice message with the three-dimensional pattern to form a feature image and stores the feature image. The first mobile device 21 further transmits the feature image to the management device 1.

In this embodiment, related information (e.g., the recognition feature, the picture-and-text image, the three-dimensional pattern) is stored in the management device 1 by the system provider, and the system provider prints the recognition feature on the physical cards 200 and provides the physical cards 200 for users (i.e., the person recited in the physical card 200). Therefore, the user can use the first mobile device 21 to execute the application program to look up his or her three-dimensional pattern in the management device 1, upload a voice message to the management device 1, and combine the voice message with the three-dimensional pattern to form the feature image.

In one embodiment, the voice message is recorded and stored in the management device 1 by the system provider in advance. Therefore, the user does not need to record the voice message and upload the voice message to the management device 1.

In one embodiment, the user can use the first mobile device 21 to execute the application program to transmit a verification cord to the management device 1 to obtain an authorization. And then, the user can use the first mobile device 21 to execute the application program to edit the feature image. For example, the user may add an additional voice message, revise the three-dimensional pattern, or revise texts.

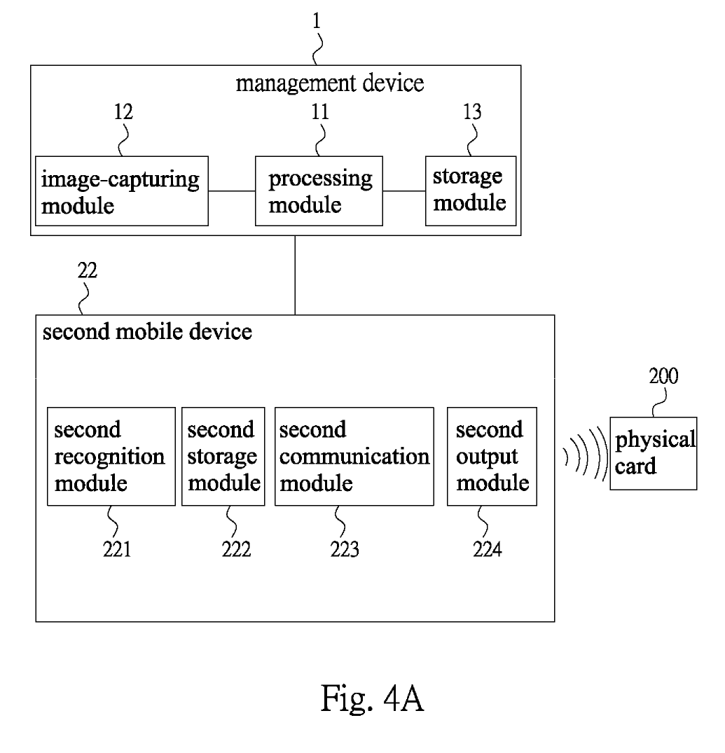

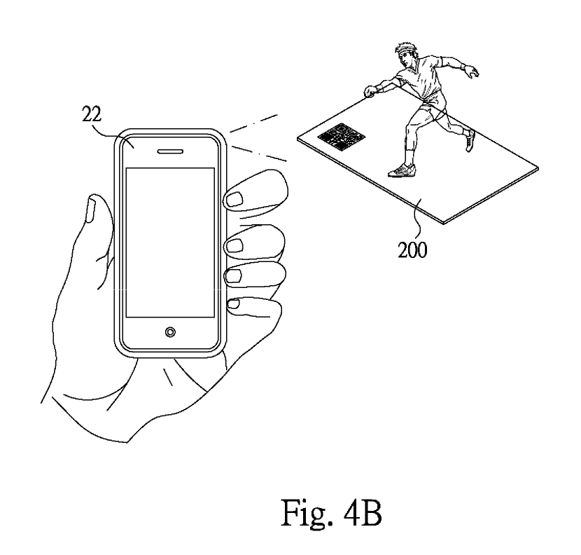

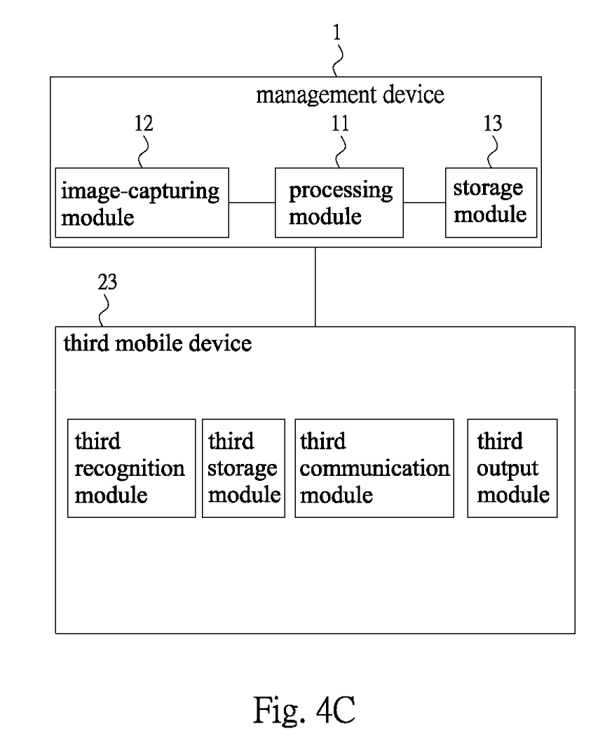

Please refer to FIGS. 4A to 4C, respectively illustrating schematic and operational schematic views of a social-network information connection system according to exemplary embodiments of the present invention. In one embodiment, a third person has a second mobile device 22. The second mobile device 22 is not the same as the first mobile device 21 but with same or similar functional modules, such as a second recognition module 221, a second storage module 222, a second communication module 223, and a second output module 224. The second storage module 222 of the second mobile device 22 also stores the application program. Therefore, when the second recognition module 221 recognizes another physical card 200 like a business card provided by the user, the second mobile device 22 correspondingly transmits the second recognition signal to the management device 1 via the second communication module 223, the management device 1 looks up the feature image according to the second recognition signal and transmits the feature image to the second mobile device 22. Next, the second mobile device 22 receives the feature image and then outputs the feature image via the second output module 224. Accordingly, a third person can know the user in an efficient and fast manner.

In one embodiment, after the third person understands the feature image of the user, the third person may transmit an endorsement to the management device 1 based on the feature image. Then, the management device 1 stores the endorsement. The endorsement may be a mood symbol or a comment for the feature image.

Conversely, when a third person tends to find a talented person, the third person may use a third mobile device 23 to set an evaluation search criterion. As shown in FIG. 4C, the third mobile device 23, like the first mobile device 21 or the second mobile device 22, executes the application program. Then, the third mobile device 23 transmits an evaluation search message to the management device 1 by executing the application program. Next, the management device 1, according to criteria in the evaluation search message, finds one or more matched feature image and transmits the matched feature image to the third mobile device 23. Hence, the third mobile device outputs the matched feature image as reference for the third person, allowing the third person to have suitable candidates for different jobs from same or different industries.

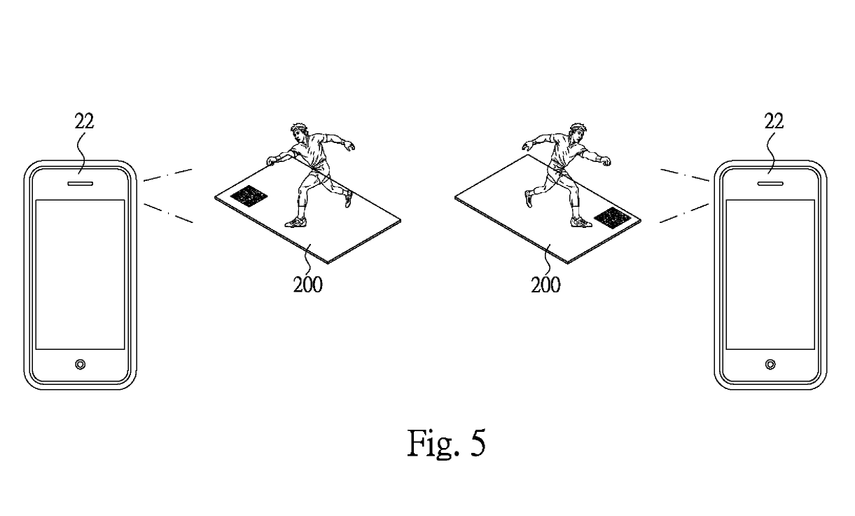

Please refer to FIG. 5, illustrating a schematic scenario of a social-network information connection system according to an exemplary embodiment of the present invention. In one embodiment, the user uses the first mobile device 21 to match with the third person's second mobile device 22. In this moment, the management device 1 further stores a recognition feature of the third person. Therefore, the user and the third person can execute the application programs on the first mobile device 21 and the second mobile device 22, respectively, to recognize their own physical cards and output their own feature images for interaction or playing games.

In one embodiment, the received feature image (i.e., the feature image of the third person) may be both transmitted to the first mobile device 21. Therefore, the first mobile device 21 outputs the two different feature images (that is, the feature image of the user and the feature image of the third person).

In one embodiment, the user and the third person use their own mobile devices to control and manipulate their own feature images. In one embodiment, the second mobile device 22 is used to receive all the information transmitted by the management device 1, and then the second mobile device 22 outputs the information to the first mobile device 21.

In one embodiment, the management device 1 classifies the feature image and the another feature image as virtual characters, and each of the virtual characters has a corresponding ability. Accordingly, the user and the third person can use their own feature images for game playing and competing with each other, increasing the entertainment for the interaction between the user and the third person.

In one embodiment, the first mobile device 21 and the second mobile device 22 are respectively connected to the management device 1 or other mobile devices. Since the management device 1 or the other mobile devices may store information related different users (like recognition features, picture-and-text images, and three-dimensional patterns), the first mobile device 21 and the second mobile device 22 can obtain desired recognition features, picture-and-text images, and three dimensional pattern, and the corresponding feature images are respectively displayed on the first mobile device 21 and the second mobile device 22 for the game playing or interaction purposes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A social-network information connection system, comprising a management device comprising a processing module, an image-capturing module, and a storage module, wherein the image-capturing module captures a physical card to generate a picture-and-text image, the processing module selects a content to be a recognition feature according to the picture-and-text image, the image-capturing module captures a physical object to generate a three-dimensional pattern, the image-capturing module further records a voice message, the storage module stores the recognition feature, the picture-and-text image, the three-dimensional pattern, and the voice message, and the processing module processes the recognition feature, the picture-and-text image, the three-dimensional pattern, and the voice message to have a relationship with each other; and
a mobile device comprising a recognition module, a storage module, a communication module, and an output module, wherein the storage module of the mobile device stores an application program, the recognition module is adapted to recognize a second physical card having the recognition feature, the mobile device executes the application program to connect with the management device to transmit a recognition signal corresponding to the recognition feature to the management device by the communication module, the management device looks up the three-dimensional pattern and the voice message according to the recognition signal and transmits the three-dimensional pattern and the voice message to the mobile device, the mobile device outputs the three-dimensional pattern and the voice message by the output module.

2. A social-network information connection system adapted to be connected with a first mobile device, the system comprising:
a management device comprising a storage module storing a recognition feature, a picture-and-text image, and a three-dimensional pattern, wherein the recognition feature, the picture-and-text image, and the three-dimensional pattern have a relationship; and
a physical card having the recognition feature;
wherein the first mobile device comprises a first recognition module, a first storage module, a first communication module, and a first output module, the first storage module stores an application program, the first mobile device executes the application program to connect with the management device, when the first recognition module recognizes the recognition feature, the first mobile device transmits a first recognition signal to the management device via the first communication module, the management device looks up the three-dimensional pattern according to the first recognition signal and transmits the three-dimensional pattern to the first mobile device, the first mobile device combines a voice message with the three-dimensional pattern to form a feature image and stores the feature image, the first mobile device further transmits the feature image to the management device.

3. A social-network information connection system adapted to be connected with a first mobile device, the system comprising:
a management device comprising a storage module storing a recognition feature, a picture-and-text image, a three-dimensional pattern, and a voice message, wherein the recognition feature, the picture-and-text image, the three-dimensional pattern, and the voice message have a relationship, and the voice message and the three-dimensional pattern are combined to form a feature image; and
a physical card having the recognition feature;
wherein the first mobile device comprises a first recognition module, a first storage module, a first communication module, and a first output module, the first storage module stores an application program, the first mobile device executes the application program to connect with the management device, when the first recognition module recognizes the recognition feature, the first mobile device transmits a first recognition signal to the management device via the first communication module, the management device looks up the feature image according to the first recognition signal and transmits the feature image to the first mobile device, the first mobile device receives the feature image and then outputs the feature image via the first output module.

4. The system according to claim 2, wherein after the first mobile device executes the application program to transmit a verification code to the management device to obtain an authorization, the first mobile device executes the application program to edit the feature image.

5. The system according to claim 3, wherein after the first mobile device executes the application program to transmit a verification code to the management device to obtain an authorization, the first mobile device executes the application program to edit the feature image.

6. The system according to claim 2, further comprising a second mobile device comprising a second recognition module, a second storage module, a second communication module, and a second output module, the second storage module stores the application program, the second mobile device executes the application program to connect with the management device, when the second recognition module recognizes a physical card having the recognition feature, the second mobile device correspondingly transmits a second recognition signal to the management device via the second communication module, the management device looks up the feature image according to the second recognition feature and transmits the feature image to the second mobile device, the second mobile device receives the feature image and then outputs the feature image via the second output module.

7. The system according to claim 3, further comprising a second mobile device comprising a second recognition module, a second storage module, a second communication module, and a second output module, the second storage module stores the application program, the second mobile device executes the application program to connect with the management device, when the second recognition module recognizes a physical card having the recognition feature, the second mobile device correspondingly transmits a second recognition signal to the management device via the second communication module, the management device looks up the feature image according to the second recognition feature and transmits the feature image to the second mobile device, the second mobile device receives the feature image and then outputs the feature image via the second output module.

8. The system according to claim 6, wherein the second mobile device transmits an endorsement to the management device based on the feature image, and the management device stores the endorsement.

9. The system according to claim 7, wherein the second mobile device transmits an endorsement to the management device based on the feature image, and the management device stores the endorsement.

10. The system according to claim 8, further comprising a third mobile device, wherein the third mobile device stores the application program, the third mobile device executes the application program to transmit an evaluation search message to the management device, the management device looks up the endorsement matched with the evaluation search message and the feature image corresponding to the endorsement according to the evaluation search message, the management device transmits the feature image to the third mobile device, and the third mobile device outputs the feature image.

11. The system according to claim 9, further comprising a third mobile device wherein the third mobile device stores the application program, the third mobile device executes the application program to transmit an evaluation search message to the management device, the management device looks up the endorsement matched with the evaluation search message and the feature image corresponding to the endorsement according to the evaluation search message, the management device transmits the feature image to the third mobile device, and the third mobile device outputs the feature image.

12. The system according to claim 10, wherein the first mobile device is matched with the second mobile device, the management device further stores another recognition feature, another picture-and-text image, and another feature image, and the another recognition feature, the another picture-and-text image, and the another feature image have a corresponding relationship, when the second mobile device recognizes a physical card having the another recognition feature, the second mobile device correspondingly transmits a third recognition signal to the management device, the management device looks up the another feature image according to the third recognition signal and transmits the another feature image to the second mobile device, the second mobile device receives the another feature image and outputs the another feature image for interacting with the feature image.

13. The system according to claim 11, wherein the first mobile device is matched with the second mobile device, the management device further stores another recognition feature, another picture-and-text image, and another feature image, and the another recognition feature, the another picture-and-text image, and the another feature image have a corresponding relationship, when the second mobile device recognizes a physical card having the another recognition feature, the second mobile device correspondingly transmits a third recognition signal to the management device, the management device looks up the another feature image according to the third recognition signal and transmits the another feature image to the second mobile device, the second mobile device receives the another feature image and outputs the another feature image for interacting with the feature image.

14. The system according to claim 10, wherein the first mobile device is matched with the second mobile device, the management device further stores another recognition feature, another picture-and-text image, and another feature image, and the another recognition feature, the another picture-and-text image, and the another feature image have a corresponding relationship, when the second mobile device recognizes a physical card having the another recognition feature, the second mobile device correspondingly transmits a third recognition signal to the management device, the management device looks up the another feature image according to the third recognition signal and transmits the another feature image to the second mobile device, the second mobile device receives the another feature image and transmits the another feature image to the first mobile device, the first mobile device outputs the another feature image for interacting with the feature image, wherein the feature image is manipulated by the first mobile device, and the another feature image is manipulated by the second mobile device.

15. The system according to claim 11, wherein the first mobile device is matched with the second mobile device, the management device further stores another recognition feature, another picture-and-text image, and another feature image, and the another recognition feature, the another picture-and-text image, and the another feature image have a corresponding relationship, when the second mobile device recognizes a physical card having the another recognition feature, the second mobile device correspondingly transmits a third recognition signal to the management device, the management device looks up the another feature image according to the third recognition signal and transmits the another feature image to the second mobile device, the second mobile device receives the another feature image and transmits the another feature image to the first mobile device, the first mobile device outputs the another feature image for interacting with the feature image, wherein the feature image is manipulated by the first mobile device, and the another feature image is manipulated by the second mobile device.

16. The system according to claim 14, wherein the management device classifies the feature image and the another feature image as virtual characters, each of the virtual characters has a corresponding interaction ability.

17. The system according to claim 15, wherein the management device classifies the feature image and the another feature image as virtual characters, each of the virtual characters has a corresponding interaction ability.
